(19) United States
(12) Patent Application Publication
(10) Pub. No.: US 2020/0331287 A1
(43) Pub. Date: Oct. 22, 2020

(54) COMPACT TOOL COMBINING VACUUM/BLOWER, PENCIL SHARPENER, RUBBERY ERASER, AND STORAGE SPACE

(71) Applicants: Cary Wang, New Canaan, CT (US); Chun Wang, New Canaan, CT (US)

(72) Inventors: Cary Wang, New Canaan, CT (US); Chun Wang, New Canaan, CT (US)

(21) Appl. No.: 16/833,553

(22) Filed: Mar. 28, 2020

Related U.S. Application Data
(60) Provisional application No. 62/828,534, filed on Apr. 3, 2019.

(51) Int. Cl. B43L 23/08; A45C 11/34; A45C 15/00; A47L 7/00

(52) U.S. Cl. CPC B43L 23/08; A47L 7/00; A45C 15/00; A45C 11/34

(57) ABSTRACT

A handheld device of compact size combining a mini electric vacuum/blower, a pencil sharpener, a rubbery eraser, and a storage unit. The inventive device has one or more containers to house a motor and rotary fan for the vacuum/blower, a battery that powers the vacuum/blower, a pencil sharpener, a rubbery eraser, and a storage unit. The vacuum is used to clean the crumbs from the rubbery eraser or other small objects on a surface, and the vacuum easily converts to a blower that will generate air steam. The storage unit can house certain sized school supplies such as crayons, pens, pencils, or other small items. The inventive of the device is compact enough so that it can be operated single handedly and it can be carried in pockets or small bags.

### CROSS-REFERENCE TO RELATED APPLICATIONS

This application claims the benefit of provisional patent application set. No. 62/828,534, filed on Apr. 3, 2019 by the present inventors.

### BACKGROUND

### Prior Art

The following is a tabulation of some prior art that presently appears relevant

U.S Patents

U.S Patents

| Patent Number | Kind Code | Issue Date | Patentee |
|---|---|---|---|
| US010582821 | B2 | March 10, 2020 | LG Electronics Inc |
| US009656361 | B2 | May 23, 2017 | Hilti Aktiengesellschaft |
| US594114 | A | November 23,1897 | John Lee Love |

### BACKGROUND

### 1. Field of the Invention

Even with the development of computer based learning, many schools around the world, especially elementary and middle schools, still require students to bring handwriting supplies to work in classrooms, as handwriting is one of the most essential skills for younger students. Typical supplies related to handwriting include writing instruments such as pencils and pens, erasers, pencil sharpeners, etc.

Commonly these supplies can be acquired separately and they are usually stored in a pencil box or a pouch. However, occasionally some of the items are misplaced or lost.

The present invention relates generally to a combination of pencil sharpening, mark erasing, vacuuming/blowing, and storage. More specifically the device fits all of the above in a compact size that can be carried in pocket or small bags and it can be operated with just one hand. It eliminates the needs to buy and carry the above items separately.

Rubbery eraser is a great tool to remove unwanted marks on paper or other surface written by pencils. However, a common complaint is about the crumbs from the erasers. Not only do they result in untidy working environment, but also they tend to stick to the surface and become difficult to remove. One of the most effective ways to remove eraser crumbs is vacuuming or blowing. The vacuum/blow function from the present invention can help create and maintain a clean working environment.

### 2. Description of the Prior Art

There are numerous patents related to suction devices, pencil sharpening, and other related apparatus.

LG Electronics Inc. (US010582821) describes a cleaner of simple structure that includes a suction motor and sufficient air passage width that generates suction force, a dust separation unit, a motor housing, and flow guide.

Hilti Aktiengesellschaft (US009656361) describes a dust removal system handheld power tool that includes fan, a suction hose, and a collecting container, and a filter with consecutive fins that are slanted to reduce the adhesion of the dust to the fin.

John Lee Love (U.S. Pat. No. 594,114) patent describes a simple, light-weight, crank-powered pencil sharpener that catches the shavings

While these devices may be suitable for the particular purpose they address, none of the above is suitable for providing a single apparatus that combines the function of pencil sharpener, eraser, vacuum/blower, and storage.

Further, the present invention can be constructed in a compact size for anyone including youth to carry and operate easily. In these respects, the present invention substantially departs from the conventional concept and design of the prior arts, and in so providing an apparatus primarily developed for the purpose of eliminating the need to acquire and carry each device separately.

### SUMMARY OF THE INVENTION

In view of the foregoing disadvantages inherent in the known types of supplies related to handwriting and cleaning now present in the prior arts, the present invention provides a new design to combine multiple functions in a compact size.
1. A primary object of the present invention is to provide a combination of functions including but not limited to: erasing unwanted surface pencil marks, vacuuming/blowing crumbs/small objects, sharpening pencils, storing small items
2. Another object is to provide a compact size tool that can be carried and operated with ease.
3. An additional object is to provide a tool that keeps the working environment clean by vacuuming/blowing the crumbs from the erasing or other small objects
4. Save time by eliminating the need to purchase each item separately
5. Reduce the likelihood of misplacing each item
6. Provide personalizing options with decorative exterior designs such as shape, color, labels, etc.
7. Main body can be manufactured in a 3d printer
8. Cost of the unit can be less expensive than purchasing each item separately
9. Option to power the vacuum through batteries or USB charging

To the accomplishment of the above and related objects, this invention maybe embodied in the form illustrated in the accompanying drawings and pictures. However the drawing and pictures are for illustrative purpose only, and changes may be made in the specific construction illustrated and described within the scope of the appended claims.

### BRIEF DESCRIPTION OF DRAWING

Various features and advantages of the present inventions will become fully appreciated in conjunction with the accompanying drawings:

FIG. 1 illustrates the operational view when the apparatus is used to vacuum or blow small objects when the cap is removed from one end

FIG. 2A to FIG. 2C illustrates the side view of each container

FIG. 3 illustrate the s cylinder structure of the apparatus and individual container

### DRAWINGS—REFERENCE NUMERALS/LETTERS

1 Electric switch
2 Small objects such as crumbs from rubbery eraser
3 Foldable hose
4 Foldable joint
5 Screw-on cap
6 Writing instrument such as crayon
7 Writing instrument such as pencil
8a Removable cap from one end
8b Removable cap from the other end
9 Rubbery eraser
10 Battery
11 Pencil sharpener
12 Motor
13 Rotary fan
14 Cylinder shape of one of the containers

### DETAILED DESCRIPTION OF EMBODIMENT

Turning now descriptively to the drawings.

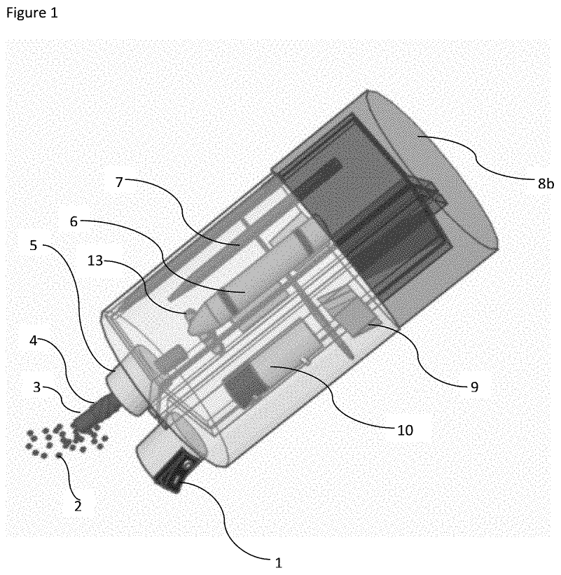

FIG. 1 illustrates an operational view when the inventive is used to vacuum or blow small objects 2 such as crumbs from the rubbery eraser 9. The air stream flows through the hose 3 that can be folded at the joint 4. The switch 1 can shift the rotary fan 13 between sucking in air and pushing air through the hose 3 into a compressed air stream. FIG. 1 also shows partial view of the container that houses the battery 10 and rubbery eraser 9, and the other container that functions as a storage space for school suppliers such as pencils 7 or crayons 6.

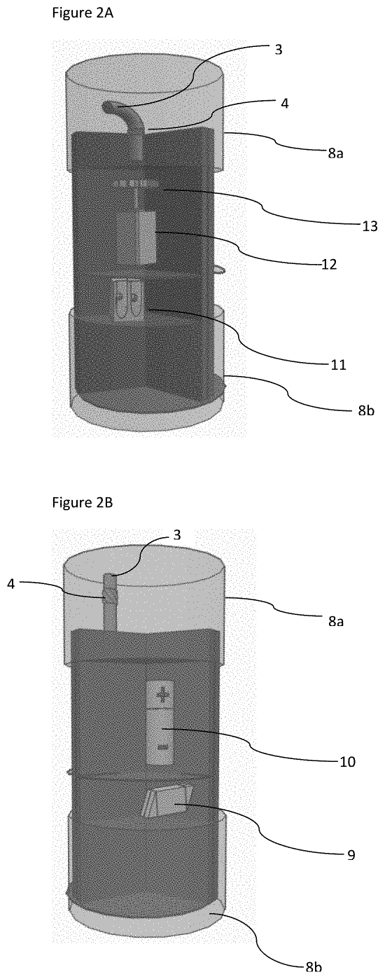

FIG. 2A illustrates the side view of the container that houses the pencil sharpener 11, the motor 12 and the rotary fan 13. When the apparatus is not in use, caps 8a and 8b from both ends can be closed.

FIG. 2B illustrates the side view of the container that houses the battery 10 and rubbery eraser 9. The battery 10 can be either rechargeable or non-rechargeable. The curved side of the container can be opened when the battery 10 is to be removed or recharged. The wires that connect the battery to the motor and switch are not shown here.

FIG. 2C illustrates the side view of the container that functions as a storage unit that user can place small items such as short pencils 7 or crayons 6. These items can be retrieved by opening the cap 8 from one end.

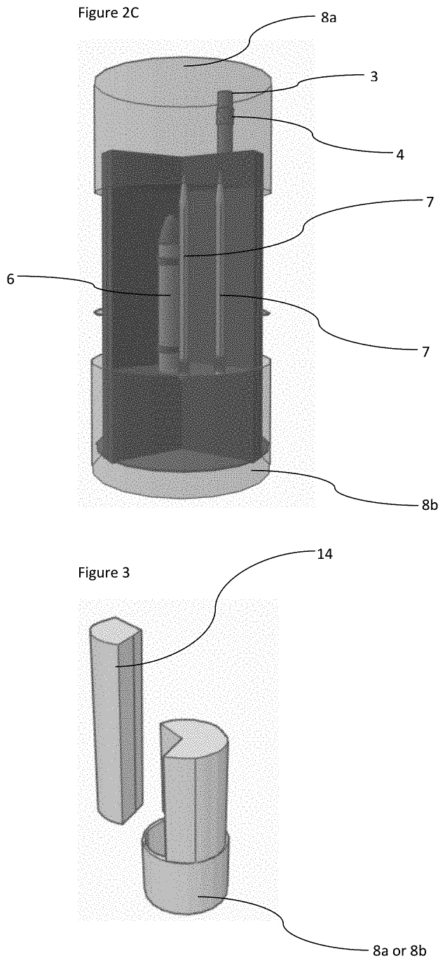

FIG. 3 illustrates the cylinder shape 14 of the containers and how each container fits well with one another.

In use, when the cap 8a is opened from one end, the user will see the vacuum/blower hose attached to a screw-on cap 5, the switch 1 to turn on/off the vacuum/blower, and the closed bottom of the storage container.

When the cap 8b is opened from the other end, the user will see the pencil sharpener 11 fixed to the inner sider of the container, a chamber for the rubbery eraser 9, and screw-on cap (not shown) of the storage unit.

With respect to the above descriptions, they may contain certain specificities. However, it is to be realized that they should not be construed as limiting the scope of embodiments, but as merely providing illustrations of the principle of the invention. The optimum construction of the invention may include variation in size, material, shape, assembly, function and manner of operation whichever are deemed obvious to one skilled in art.

Since numerous modifications and changes will readily occur to those skilled in art, it is not desired to limit the invention to the exact construction and operation shown and described, and accordingly the scope of the embodiments should be determined by the claims in this application and their legal equivalent, rather than by the examples shown above.

In addition, the inventors have built a working model with most functions describe above. One of the inventors, 11 year old Cary Wang has demonstrated the invention to his school district's innovation night on Apr. 10, 2019. Cary also named his invention “Mini Handy Buddy”.

1. A handheld apparatus with a structure comprising one or more divided containers with each container housing a device or tool including but not limited to: pencil sharpener, mini vacuum/blower, rubbery eraser, and storage area

2. A handheld apparatus of claim 1 wherein said includes containers that fits each other in a compact size that could be carried in regular pocket or small bag and it can be operated single handedly

3. A handheld apparatus of claim 1 wherein said is of a cylinder shape or other shapes that can be carried and operated with ease

4. A handheld apparatus of claim 1 wherein said include removable caps for both ends to cover the container(s)

5. A handheld apparatus of claim 1 wherein said includes a pencil sharpener and a mini vacuum/blower, both of which are permanently fixed in one of the containers

6. A handheld apparatus of claim 1 wherein said includes a hose of the mini vacuum/blower that can be folded or retracted for cap to close

7. A handheld apparatus of claim 1 wherein said includes a mini vacuum/blower that can be powered by battery, either chargeable or non-rechargeable

8. A handheld apparatus of claim 1 wherein said includes a container that houses the vacuum/blower motor and fan with a screw-on cap for ease of emptying the crumbs and small objects

9. A handheld apparatus of claim 1 wherein said includes a container that functions as a storage with a screw-on cap

10. A handheld apparatus of claim 1 wherein said can be built with 3D printer
